(19) United States
(12) Patent Application Publication
(10) Pub. No.: US 2019/0240720 A1
(43) Pub. Date: Aug. 8, 2019

(54) EQUIPMENT AND PROCESSES FOR MAKING GASKETS AND WASHERS WITH ADJUSTABLE DIMENSIONING AND KITS DIRECTED TO THE SAME

(71) Applicant: James Duignan, Guelph (CA)

(72) Inventor: James Duignan, Guelph (CA)

(21) Appl. No.: 15/890,428

(22) Filed: Feb. 7, 2018

(51) Int. Cl. B21D 53/20

(52) U.S. Cl. CPC B21D 53/20; F16B 43/001

(57) ABSTRACT

Operation of a cutting mechanism provides an annular gasket or washer from a suitable solid gasket or washer material. The cutting mechanism includes a body defining a passage with an opening and a cutting head. The cutting head translationally retracts into the passage through the opening and projects from the passage through the opening along a longitudinal axis of the mechanism. The cutting head carries multiple cutters and can be selectively rotated about the axis when projecting through the opening from the passage. The position of each of the cutters is adjustable along a radial range of distances from the axis to correspondingly set an inner diameter and an outer diameter of the gasket or washer.

### BACKGROUND

The present application relates generally to unique techniques, systems, methods, processes, apparatus, devices, and kitting for forming gaskets and washers; and more particularly, but not exclusively, relates to a gasket or washer cutter including a cutting head that turns about a rotational axis and carries one or more cutters each radially positionable relative to a radial segment extending perpendicularly from the rotational axis.

Gaskets and washers are a near ubiquitous component of many engines, motors, and other devices. Even the most ambitious machinist shop or hobbyist often lacks the gasket or washer inventory needed to avoid an unexpected delay in a project that results when the needed gasket or washer cannot be found in the inventory. Several schemes have arisen to address this problem, but many are complex, and fail to efficiently overcome the problem under certain circumstances. Accordingly, there remains a need for further contributions in this area of technology.

By way of transition from this Background to subsequent sections of the present application, any word, phrase, term, acronym, abbreviation, definition, expression, explanation, label, symbol, or other terminology in the numerical listing below is provided to determine the meaning of the same to the extent consistent with applicable rules and laws. Any of these numerical entries may be supplemented by example or further explanation where deemed appropriate. Among other things, these definitions are provided to: (a) resolve meaning sometimes subject to ambiguity and/or dispute in the applicable field(s) and/or (b) exercise the lexicographic discretion of any named inventor(s), as applicable:
1. “Metalloid” means one or more of any of the following chemical elements: antimony (Sb), arsenic (As), astatine (At), boron (B), germanium (Ge), polonium (Po), selenium (Se), silicon (Si), and tellurium (Te). Several reputable sources consulted are generally consistent in listing B, Si, Ge, As, Sb, and Te as metalloids, but are in conflict as to the inclusion of other elements, with some lists totaling as many as eleven elements. To dispel any doubt, each element listed refers to all of its isotopes (if any) whether considered stable or not.
2. “Metal alloy” means a chemical compound that includes two or more different metal elements, at least one metal element and at least one metalloid element, or any combination of these and may have a total content of one or more elements other than metals or metalloids that is less than or equal to five percent (≤5%). Such content may be comprised of one or more constituents, impurities, or a combination of both. Unless expressly stated to the contrary, isotopic variation of among one or more elements in a metal alloy (whether metal, metalloid, or otherwise) has no bearing on this definition.
   Any definition, understanding, and/or meaning as set forth in the immediately preceding numerical listing shall apply throughout the present application unless expressly stated to the contrary. Further, any word, phrase, term, acronym, abbreviation, expression, explanation, label, statement, symbol, or the like defined with brackets, braces, parentheses, quotation marks, or the like in the present application shall have such meaning wherever appearing throughout the present application unless expressly stated to the contrary in connection therewith or unless in conflict with any definition set forth in the immediately preceding numerical listing, in which case the definition in the listing shall prevails.

### SUMMARY

Among the embodiments of the present application are unique systems, apparatus, methods, kits, processes, combinations, mechanisms, and devices to make gaskets and washers from a suitable material. Other embodiments include unique techniques to design, prepare, cut, inscribe, form, make, generate, separate, apply, and/or use a gasket and/or washer.

A further technique of the present application includes: operating a cutting mechanism including a body defining a passage with a first opening opposite a second opening, a plunger with a first plunger end portion opposite a second plunger end portion, a cutting head including a first side opposite a second side, the plunger extending through the second opening with the second plunger end portion positioned outside the body and the first plunger end portion connected to the head along the first side, the plunger and the head being rotatable relative to the body about a rotational axis extending through the first opening and the second opening; adjusting a first threaded interface to connect a first cutter along the second side of the head a first distance from the axis corresponding to the outer diameter; adjusting a second threaded interface to connect a second cutter along the second side of the head a second distance from the axis corresponding to the inner diameter; penetrating the material at least part way through with the first cutter and the second cutter; and during the penetrating of the material, turning the plunger about the axis an amount at least sufficient to mark an annular shape in the material with the first cutter and the second cutter in correspondence to the gasket or washer.

Another embodiment of the present application comprises a cutting mechanism which includes: a body defining a passage therethrough that terminates with a first opening bounded by a rim and a second opening positioned opposite the first opening; a plunger including a first plunger end portion opposite a second plunger end portion and a central plunger portion extending therebetween—the central plunger portion extends through the second opening into the passage to position the second plunger end portion external to the body; and a cutting head with a first side opposite a second side with the first plunger end portion being connected to the head along the first side and the head being structured to rotate with the plunger about a rotational axis and move with the plunger in translation along the axis. The head includes: a first cutter connected to a first carrier positioned between the first cutter and the second side and defining a first threaded passageway engaged to establish a first position of the first cutter a first radial distance from the axis; a second cutter connected to a second carrier positioned between the second cutter and the second side that defines a second threaded passageway engaged to establish a second position of the second cutter a second radial distance from the axis different than the first radial distance; and a guideway engaged to one or more of the first carrier and the second carrier with a threaded shaft. The mechanism also includes a spring positioned about at least part of the central plunger portion and including a first end portion contacting the body and a second end portion contacting the second plunger end portion. The spring includes stiffness sufficient to push the plunger and the body away from one another to place the head in a retracted position within the passage when at rest, and to compress the spring in response to manually pushing the body and the second portion together to move the head into a cutting position with the first cutter and the second cutter at least partially projecting out of the passage through the first opening past the rim.

The above introduction is not to be considered exhaustive or exclusive in nature—merely serving as a forward to further advantages, apparatus, applications, arrangements, aspects, attributes, benefits, characterizations, combinations, components, compositions, compounds, conditions, configurations, constituents, designs, details, determinations, devices, discoveries, elements, embodiments, examples, exchanges, experiments, explanations, expressions, factors, features, forms, formulae, gains, implementations, innovations, kits, layouts, machinery, materials, mechanisms, methods, modes, models, modalities, objects, options, operations, parts, processes, properties, qualities, refinements, relationships, representations, species, structures, substitutions, systems, techniques, traits, uses, utilities, and/or variations that shall become apparent from the description provided herewith, from any claimed invention, drawing, and/or other information included herein.

### BRIEF DESCRIPTION OF THE DRAWING(S)

For any figure introduced in the following description, like reference numerals refer to like features already set forth in the description for one or more other figures introduced earlier. When there are multiple occurrences of a feature in a given figure, not all such features may be designated by reference numeral to preserve clarity.

FIG. 1 is a partially schematic view of a kit including a cutting mechanism as it extends along its longitudinal and coincident rotational axis R-R parallel to the FIG. 1 view plane. Cutting mechanism includes a cutting head depicted in a retracted position. A cut-away into the body of the cutting mechanism is provided to better illustrate the same.

FIG. 2 is a partially schematic view of a portion of the kit of FIG. 1 with the cutting head in a cutting position including a cutter penetrating material from which a gasket or washer may be made. A cross section through the cutting mechanism body is provided to better illustrate the same.

FIG. 3 is a partially schematic, sectional view of a portion of the kit of FIGS. 1 and 2 including the cutting head with its cutters depicted end-on. FIG. 3 corresponds to the section line 3-3 shown in FIG. 1 and is oriented so that the FIG. 3 view plane is perpendicular to the view planes of both FIGS. 1 and 2. The rotational center point designated by crosshairs RC in FIG. 3 is coincident with axis R-R shown in FIGS. 1 and 2.

FIG. 4 is a partially schematic, sectional view of a portion of the cutting head depicting a cutter carrier depicted in correspondence to section line 4-4 shown in FIG. 3. The depiction of FIG. 4 is inverted relative to FIGS. 1 and 2 and its view plane is perpendicular to the view plane of FIG. 3.

FIG. 5 is a partially schematic view of the cutting head showing multiple cutters/carriers in correspondence to the view line 5-5 shown in FIG. 3 except that the body of the cutting mechanism is not shown to enhance clarity. The view plane of FIG. 5 is perpendicular to the view plane for each of FIGS. 1-4.

FIG. 6 is a partially schematic, comparative view of a portion of a cutting head with multiple cutters/carriers relative to a gasket or washer formed therewith. The FIG. 6 cutting head depiction is like that of FIG. 5 except inverted and shown with less detail to provide sufficient room for the gasket or washer comparison on a single sheet without undue overcrowding of features, reference numerals, or the like.

FIG. 7 is a partially schematic, cut away view of a cutting head with multiple cutters/carriers shown end-on for another arrangement of the present application. The FIG. 7 cutting head is interchangeable with the cutting head depicted in FIGS. 1-6 so that the balance of the cutting mechanism can be used with either arrangement. The FIG. 7 view plane is parallel to that of FIG. 3 and perpendicular to those of FIGS. 1, 2, and 4-6.

FIG. 8 is a partially schematic, partial sectional view of a portion of the cutting head shown in FIG. 7 corresponding to the section line 8-8 shown in FIG. 7. The view plane of FIG. 8 is perpendicular to the view plane of FIG. 7.

FIG. 9 is a partially schematic view of a portion of a carrier and cutter in correspondence to the view line 9-9 shown in FIG. 7. The view plane of FIG. 9 is perpendicular to the view planes of both FIGS. 7 and 8.

FIG. 10 is a flowchart of one procedure for making a gasket or washer that may be performed with the equipment described herein and/or that illustrated in FIGS. 1-9.

### DETAILED DESCRIPTION OF REPRESENTATIVE EMBODIMENTS

In the following description, various details are set forth to provide a thorough understanding of the principles and subject matter of each invention described and/or claimed herein. To promote this understanding, the description refers to representative embodiments—using specific language to communicate the same accompanied by any drawing(s) to the extent the description subject matter admits to illustration. In other instances, when the description subject matter is well-known, such subject matter may not be described in detail and/or may not be illustrated to avoid obscuring information to be conveyed hereby.

Those skilled in the relevant art will recognize that the invention(s) set forth in the description and any claim(s) can be practiced without one or more specific details that may be included in the more fully described embodiment. It is also recognized by those skilled in the relevant art that the full scope of an invention described and/or claimed herein can encompass more detail than that made explicit herein. Such detail can be directed to apparatus, applications, arrangements, combinations, components, compositions, compounds, conditions, configurations, constituents, designs, devices, elements, expressions, features, forms, formulae, features, implementations, kits, modifications, materials, mechanisms, methods, modes, operations, parts, processes, properties, qualities, refinements, relationships, routines, structures, systems, techniques, and/or uses—just to name a few. Accordingly, this description of representative embodiments should be seen as illustrative only and not limiting the scope of any invention described and/or claimed herein.

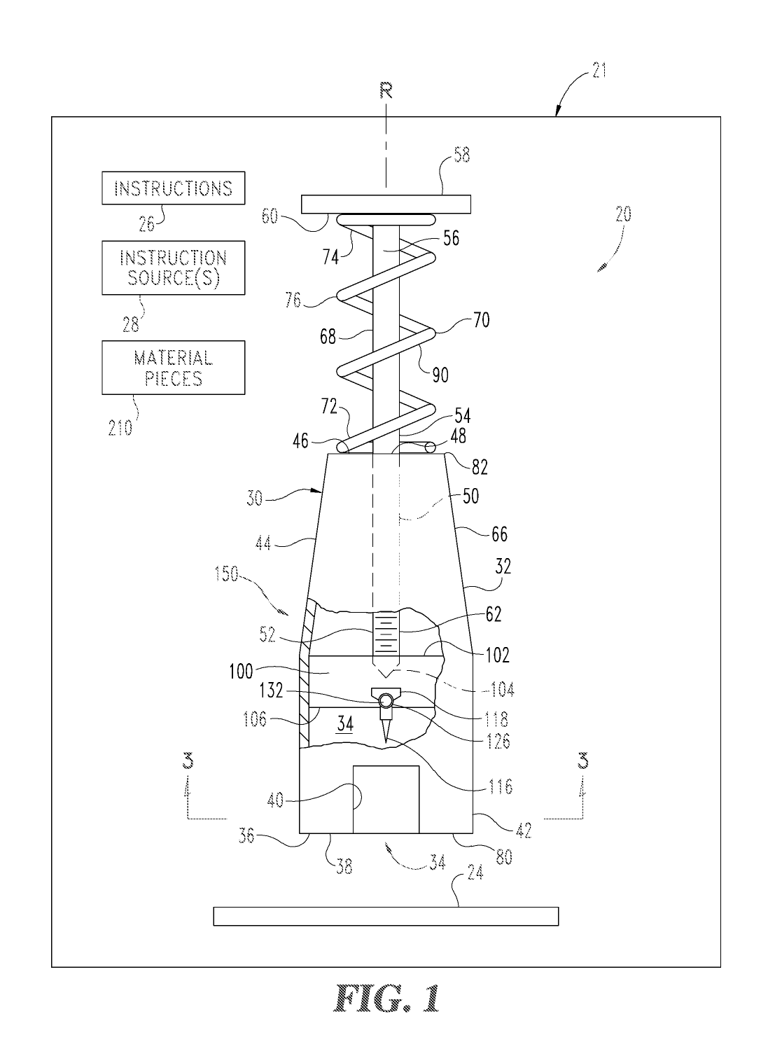

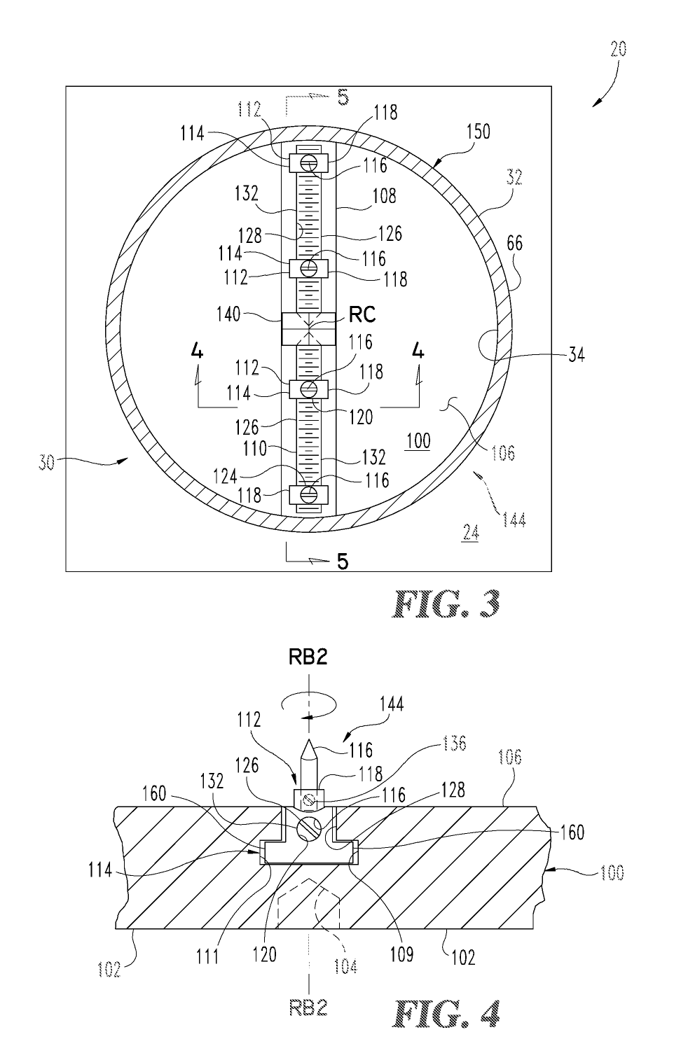

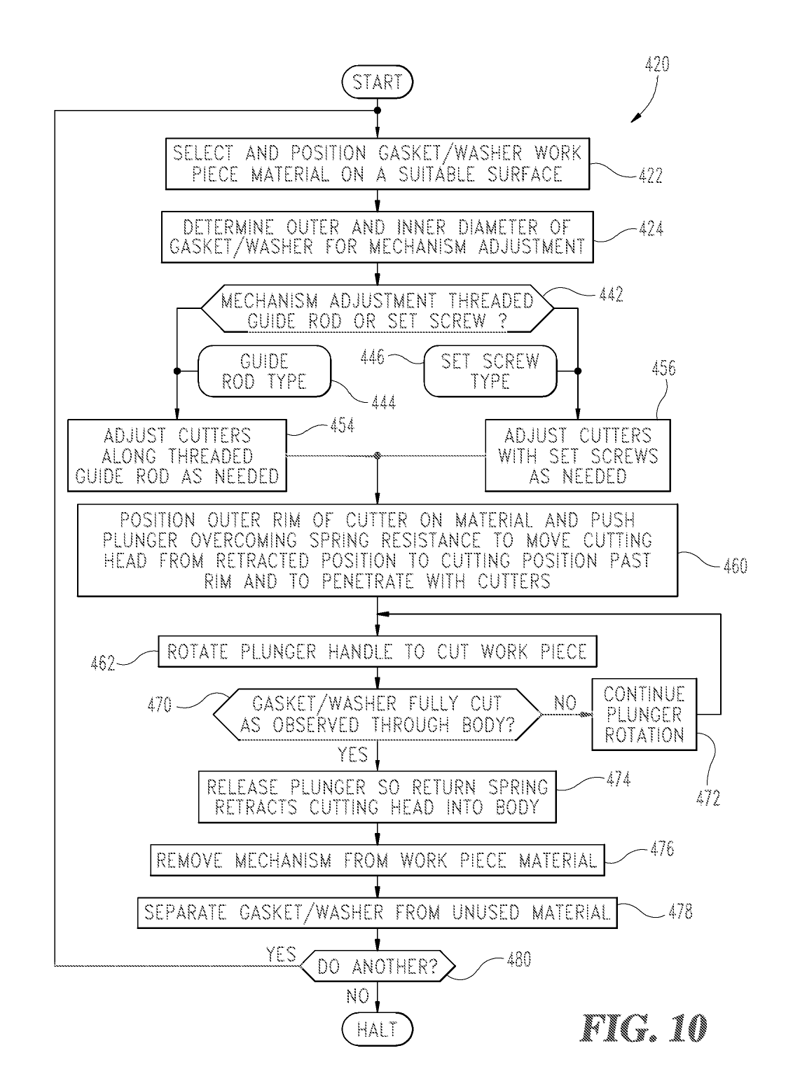

FIG. 1 depicts system 20 to form gaskets and/or washers from a wide variety of materials and/or with one or more user selectable dimensions within certain ranges. As depicted, system 20 is arranged as a gasket or washer formation kit 21 that comprises certain durable equipment, consumable supplies (like gasket/washer material), and related information. In the depicted embodiment, kit 21 includes packaging 22 to at least initially transport/deliver these items to an operator/user with suitable protection of the contents thereof. In certain embodiments, packaging 22 includes at least one case or container to store and/or organize some or all of the items included in kit 21 on a long-term basis. These kit 221 items include cutting mechanism 30 for making gaskets or washers of varying size and/or shape from a suitable solid material that is typically in the form of a generally flat sheet—although in other embodiments the form factor may vary from a flat sheet to some degree. By way of nonlimiting example, kit 21 includes gasket/washer work piece material 24 shown “edge-on” in FIG. 1. The composition of the material from which the gasket or washer is formed may vary in correspondence with a number of different factors relating to application, surrounding environment, and the like. Cutting mechanism 30 is structured to form a gasket or washer from material 24 with one or more dimensions quantifiably selected through appropriate adjustment of mechanism 30. In the usual application, cutting mechanism 30 is configured to define a ring or annulus-shaped gasket or washer from material 24 that has an inner diameter (ID) and an outer diameter (OD). Cutting mechanism 30 is structured to provide the gasket or washer with a user-selected ID and/or OD from a suitably wide range, and ID/OD can be changed through simple operator adjustment of certain parts of cutting mechanism 30. For unusual situations where the selection range is insufficient, cutting mechanism 30 itself simply can be resized to accommodate a different desire range and will become more fully apparent from subsequent description herein. Accordingly, for a target gasket/washer specification, cutting mechanism 30 quantitatively establishes the gasket/washer ID size (and corresponding inner radius) and/or the gasket/washer OD size (and corresponding outer radius). The components and operations related to annulus size-selection are described further in connection with FIGS. 3-10 hereafter. Also, more complex gasket/washer shapes shall be described in connection with FIG. 10 hereafter, including an annulus-like type for which the inner and/or outer diameter/radii varies relative to a common center (providing a form of “compound” diameter/radius), others with differently sized apertures in the same gasket, and still other gaskets have rectilinear and curvilinear peripheral segmentation, or the like. However, more description directed to kit 21, along with further description of cutting mechanism 30, including various different nonlimiting forms, arrangements, embodiments, and refinements are considered as follows first.

In the FIG. 1 depiction, Packaging 22 also includes text-based written instructions 26 and/or visually communicates some or all of instructions 26 without text, using one or more booklets, instruction cards, manuals, or the like contained therein. Alternatively or additionally, packaging 22 may present some or all of such information on the packaging exterior. Instructions 26 provide information on how to properly set-up, adjust, use, and maintain cutting mechanism 30, as well as provide pertinent safety information and warnings regarding cutting mechanism 30 use and application. Instructions 26 may also include: information about where to obtain a suitable service provider for inspection and/or repair of cutting mechanism 30, sourcing of replacement gasket or washer materials, and/or how to determine what composition of material 24 to use for a given gasket/washer application/environment. Packaging 22 also encloses and/or displays writing to direct the user of kit 21 to various other instruction/information sources 28 which additionally or alternatively may provide information as to assembly of mechanism 30, usages of it, repair of it, etc. . . . . Sources 28 include gasket/washer supplier contact and registration information, supplier website(s), suggested cutting mechanism 30/kit 21 service provider contact information for repairs, sponsored chat room/blog for interested users, and/or possibly information about gasket/washer material that can be ordered by phone or online from one or more suppliers. Information may be supplied in several languages through instructions 26 and/or through one or more of instructional sources 28.

The composition of a gasket or washer is selected to match its application, environment, and similar requirements. In certain embodiments (like some for an annulus-shaped gasket/washer), the gasket/washer material is a suitably solid substance and is approximately of a flat/planer sheet-like form that has some degree of resilience and flexibility—typically being selected to fill-in gaps and irregularities between two other components for which it is made. These other components are typically less resilient and/or harder than the gasket/washer material. Composition selection factors may include gasket/washer: size, shape, planarity, resiliency, flexibility, quantity desired, mechanical form (unitary piece, woven or unwoven fabric, composite, laminated, etc.), proximity to various chemicals and components with which the material may react unacceptably (especially any hazardous and/or caustic chemical exposure), operating temperature range, operating humidity range, operating altitude range, and other factors as applicable. In some situations, gasket/washer material may be comprised in whole or in part from a liquid that is dried, cured, and/or otherwise treated to convert it from a highly viscous form to a solid state before applying cutting mechanism 30. In a further embodiment, the gasket or washer retains qualities of both a solid and a liquid—such as a thick paste, highly viscous sealing material having some tendency to flow at a very slow rate. While by no means exclusive, a few preferred materials include one or more of: natural rubber, synthetic rubber, a nonwoven felt fabric, a nonwoven mat of fibers, leather, any of several different woven fabric types, paper or a similar cellulose-based substance, silicone, cork, neoprene, a suit metal, mica, Polytetrafluoroethylene (PTFE or Teflon), a polymeric organic thermoplastic substance, and/or a polymeric organic thermoset substance. For certain more preferred applications, the material is composite based—being composed of two or more different constituents. In one form, the composite is multilayered having an organic polymer resin layer interleaved with an inorganic layer. Some preferred composites include one or more suitable organic polymer resins with a fiber fill material dispersed throughout the resin. In one more favored refinement, fibers are distributed or positioned in accordance with some type of pattern—like the application of a reinforcing fiber fabric to which one or more organic thermoplastic and/or thermoset polymeric resins are applied. Such resin application is followed by any desired resin treatment or curing thereof and then adding another reinforcing fiber fabric layer to the extent needed to obtain desired results. Several alternating resin/fiber fabric layers may be applied to achieve the desired result. In one even more favored refinement, the fiber fabric is woven from one or more of: glass, KEVLAR, and/or carbon fibers to provide a corresponding fiber-reinforced fabric or other type of strengthening resin fill. Alternatively or additionally, fibers may be randomly oriented in the resin layer to serve as a reinforcing fill and/or unwoven fibers may be placed with a particular orientation—like the length of each fiber is generally positioned to run in the same direction through a resin layer or the like to impart one or more related anisotropic properties either with or without random fill and/or woven or unwoven fiber fabric layers. Other fill-type composite of a more preferred type includes (1) one or more organic polymer resins and (2) one or more inorganic fibers/filaments selected from the group consisting of: a metal, a metal alloy, a metalloid, a ceramic, a glass-ceramic, glass, and/or an oxide fill material. Such material may be arranged with an isotropic or anisotropic fiber orientation, and/or includes a reinforcing fabric comprised of the fibers. Yet an even more preferred composite includes one or more organic polymer resins and a fill material comprising one or more carbon allotropes selected from the group consisting of: carbon nanotubes, graphite, fullerenes, graphene, amorphous carbon, carbyne (linear acetylenic carbon), carbon nanofoam, and glassy carbon.

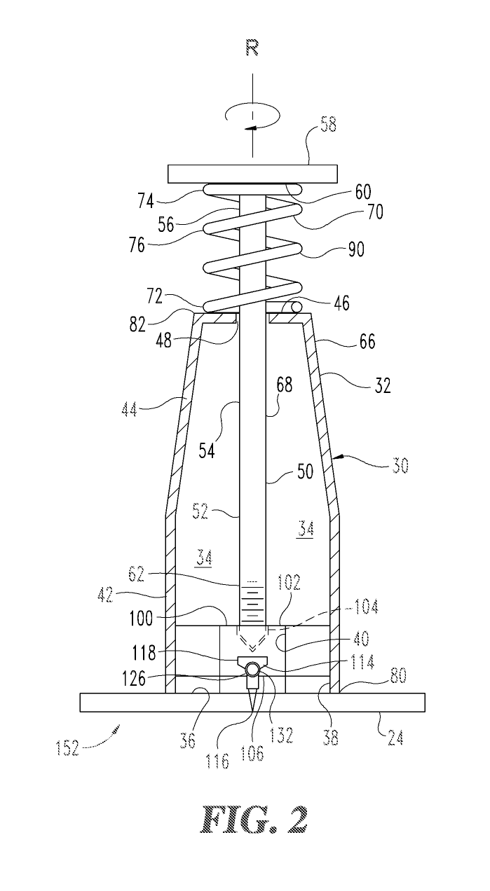

Referring to FIGS. 1 and 2 together, cutting mechanism 30 and material 24 are illustrated in two different operational configurations. In FIG. 2, cutting mechanism 30 is in contact with the gasket/washer material, penetrating it with the cutters 116. In the depicted embodiment of FIGS. 1 an 2, cutting mechanism 30 has a longitude and centerline coincident with rotational axis R-R. Although in other embodiments, one or more of these axes may vary from one or more others. In relation to axis R-R, detailed description of rotational aspects of cutting mechanism 30 takes place in connection with FIGS. 3-10. Cutting mechanism 30 includes elongate body 32 that also generally extends along rotational axis R-R and has a longitude and centerline coincident therewith. Body 32 is generally hollow, being shaped as a rigid shell with annular wall 66 that is symmetrically disposed about axis R-R. Correspondingly, body 32 defines elongate passage 34 extending along axis R-R through body 32 from end 80 to end 82. Body 32 and passage 34 are generally coextensive from end 80 to end 82 along axis R-R. Passage 34 opens externally at each end 82 of body 32. At end 80 passage 34 terminates with opening 38, and at end 82 passage 34 terminates with opening 48.

Body 32 is comprised of body end portion 42 opposite body end portion 44. To enhance understanding, body 32 is sometimes described in terms of its opposing body end portions 42 and 44 because each has a different shape and operate differently in some respects; however, it should be understood this approach does not restrict body 32 to a two piece configuration. Body 32 may be formed from a single, unitary piece of material by molding, casting, machining, or the like (inclusive of portions 42 and 44 as part of the whole); or alternatively formed from two or more pieces joined to each other by adhesive, fasteners, welding, brazing, or the like (that may or may not correlate to portions 42 and 44). Body end portion 42 and body end portion 44 meet and are rigidly fixed together approximately in the middle of body 32 with respect to the longitudinal distance of body 32 along axis R-R. Body end portion 42 includes rim 36 at end 80. Rim 36 provides the outer margin of opening 38 imparting an approximately circular shape with a center generally coincident with a point along axis R-R. The shape of body end portion 42 approximates a right circular cylinder with a longitudinal centerline generally coincident with axis R-R. As body end portion 42 extends along axis R-R from end 80 towards body end portion 44, body end portion 42 has generally constant inner and outer diameters that perpendicularly intersect axis R-R at the diameter center. Opening 38 has a diameter perpendicularly intersecting axis R-R that is generally the same as the inner diameter of body end portion 42, and each has generally the same center coincident with a corresponding point along axis R-R.

In contrast to body end portion 42, body end portion 44 is approximately shaped like a frustum with its largest diameter (corresponding to its frustum base) where body end portion 44 and body end portion 42 meet. This frustum base diameter is the largest diameter of body end portion 44. Body end portion 44 terminates at end 82. Just prior to this termination, body end portion 44 has an annular ledge 64 (FIG. 2) extending radially inward from annular wall 66 towards axis R-R up to passage 34. Passage 34 terminates with opening 48 that is generally circular and concentric with axis R-R. Ledge 64 provides a circumferential collar about opening 48. This collar defines the margin of opening 48 and is inset from annular wall 66 a certain amount.

The diameter of body end portion 44 across axis R-R is largest at the frustum base where it approximately matches the diameter of body end portion 42. As body end portion 44 extends from the frustum base towards end 82, body end portion 44 converges towards and about axis R-R, with a corresponding reduction in the inner and outer diameters of body end portion 44—becoming smallest when annular ledge 64 is reached. With this tapering down of body end portion 44 from its base towards end 82, it should be appreciated that opening 48 has a considerably smaller diameter than opening 38—particularly accounting for annular ledge 64 connected to body end portion 44 just before end 82 is reached.

It should be appreciated that body 32 also includes a window with at least one visual observation portion 40 having a degree of transparency sufficient to suitably view operation in passage 34 from outside body 32 through portion 40. While only one visual observation portion 40 is depicted to preserve clarity, it should be appreciated that in certain embodiments, a greater number of portions 40 and/or more expansive/larger portions 40 are included in body 32 (not shown). In yet another embodiment, some, if not all, of body 32 is made of a material with a level of transparency adequate to suitably view passage 34 and any operations taking place therein from an observation point outside of body 32 through such material. Alternatively or additionally, still other embodiments include one or more apertures formed through body 32 for visual observation without need to look through an intervening material. In a further favored embodiment, body 32 is formed in whole or in part from a material based on one or more thermoplastic and/or thermoset organic polymers that has sufficient transparency to suitably view or inspect passage 34 within body 32 from outside body 32 through the material.

In still other embodiments, body 32 is made in whole or in part of one or more organic polymers of the thermoplastic or thermoset type that is too translucent or opaque to provide for suitable visual observation through it from outside of body 32. In yet other embodiments, some or all of body 32 is made of a composite including a combination of one or more organic polymeric resins and one or more reinforcing fibers/fillers too translucent or opaque for external visual observation. In one such favored arrangement, body 32 is made in whole or in part of a composite including one or more organic polymeric resin types combined with a fill material including one or more of: glass, glass-ceramic, KEVLAR, metal, metal alloy, ceramic, and carbon, that may or may not provide for visual observation from outside body 32. In a favored refinement of this arrangement, carbon is at least one of the fillers in the form of one or more of: carbon nanotubes, graphite, fullerenes, graphene, amorphous carbon, carbyne (linear acetylenic carbon), carbon nanofoam, and glassy carbon. In a further embodiment, some or all of body 32 is made of a multilayer composite with one layer having a different composition than another. In others, body 32 includes in whole or in part one or more of a: metal, metal alloy, glass, ceramic, glass-ceramic, natural biologic material (such as wood), previously unstated inorganic substance, and/or any combination of these.

Cutting mechanism 30 also includes plunger 50 with opposing plunger end portions 52 and 56 and plunger central portion 54 extending between plunger end portions 52 and 56. As depicted, plunger 50 is generally symmetric with respect to axis R-R which is approximately coincident with the longitude and centerline of plunger 50. Plunger 50 extends through opening 48 to position at least some of plunger end portion 52 in passage 34 and maintain at least some of plunger end portion 56 outside of passage 34 (and body 32) under nominal conditions of use. Accordingly, plunger central portion 54 bridges plunger end portions 52 and 56 and partly extends into passage 34 through opening 48 while it also partly remains outside of body 32 (outside of passage 34). Handle 58 is the terminal portion of plunger end portion 56, and is sized and shaped so that it will not fit through opening 48 of body 32, while the remainder of plunger 50, plunger shaft 68, is sized and shaped to readily pass through opening 48 and support reciprocating up-and-down motion of plunger 50 into and out of passage 32 of body 32 and furthermore provide for rotation of plunger 50 as it extends at least part way through opening 38 defined by rim 36 for cutting in the cutting position 52. Handle 58 is in the form of a plunger operating knob that joins the elongate shaft 68 of plunger 50 at or near the terminus of shaft 68 depending on the manner joined together. The fixed connection of shaft 68 and handle 58 together can change position relative to body 31 when cutting mechanism 30 is nominally structured and operated, but some degree of separation between this connection and body 32, passage 34, and opening 48 along axis R-R remains.

Opposite handle 58, plunger end portion 52 terminates in a blunt taper with threading 62. Cutting mechanism 30 further includes a right circular cylinder-shaped or disk-shaped cutting head 100 that slides into passage 34 through opening 38. Head 100 includes side 102 opposite side 106. Along side 106 position-adjustable cutters 116 are included in carriers 118 that facilitate repositionable connection to cutting head 100 via a connection interface further described in connection with FIGS. 3-9. Side 102 defines annular recess 104 into cutting head 100; where recess 104 is centered with respect to axis R-R and includes threading that is compatible with threading 62 of plunger 50 along the terminus of plunder end portion 52. Recess 104 only partially penetrates cutting head 100 but with a depth sufficient to reliably maintain the threaded connection between plunger 50 and cutting head 100, but not so deep as to threaten the integrity of cutting head 100 otherwise.

As depicted in FIGS. 1 and 2, the blunt pointed end of plunger shaft 68 with threading 62 passes through opening 48 into body 32 and corresponding passage 34. If moved to one extreme, plunger 50 is inserted into body 32 until handle 58 makes impassable contact with the termination of annular wall 66 and/or annular ledge 64 at end 82. For this extreme, cutting head 100 would likely push cutting head 100 as far as permitted by the equipment to be stopped from any further movement by body 31 at end 82 with the plunger shaft perhaps extending all the way through passage 34 or at least placing cutting head 100 partway past rim 36 so that cutting head 100 can be held fixed as plunger 50 is rotated in a clockwise direction relative to cutting head 100 until a suitably tight, intermeshed threading connection between plunger 50 and recess 104 is established.

Continuing to disregard any influence of spring 70, certain basic mechanical aspects can be considered when the body 32, plunger 50, and cutting head 100 are properly assembled together. This assembly includes body 32 with opposing ends 38 and 48 serving as the platform or base for the rest of the assembly—namely body 32 and the plunger 50. The first step inserts the bluntly pointed, threaded 62 end of plunger 50 into body 32 through opening 48. With formation of the plunger 50/cutting head 100 threaded connection, plunger 50 and cutting head 100 move together as a unit. Initially, it should be noted that handle 58 is shaped and sized so it cannot pass into passage 34 of body 32 through opening 48. Thus, at one extreme, as body and handle are moved towards each other, plunger 50 motion though body 32 will continue until handle 58 reaches end 82 of body 32, where it is blocked from further motion in that direction by the annular ledge 64 and/or surrounding material of body 32 at end 82.

When assembled together there is a range the handle 58/plunger 50/cutting head 100 subassembly can move relative to or through body end portion 42 of body 32. Given the diameter of cutting head 100 is nearly the same as or slightly smaller than the diameter of opening 38 and the inner diameter of body end portion 42, another travel constraint results. Specifically, the amount the plunger/cutting head subassembly can be moved toward end 82 by pulling with handle 58 away from body 32 is limited because the shape and size of cutting head 100 eventually will contact the interior of body end portion 44 given its progressive reduction in size (diameter) in that direction. Such contact would typically involve minimal contact in the vicinity of the periphery of cutting head 100 about side 102 under nominal use. In other words, the increasing convergence of body end portion 44 when traveling from end 80 to end 82 acts as a trap, block, or stopper with respect to cutting head 100, while head 58 size relative to opening 48 limit the amount of travel in the other direction. Because body end portion 42 defines a generally uniform inner diameter that is also the same for opening 38, cutting head 100 can be moved via plunger 50 from the point where the cutting head 100 is blocked by the geometry of body end portion 44, being unable to travel closer to end 82, while plunger shaft 68 is sized to permit cutting head 100 to at least partly extend out of opening 38 when assembled with plunger 50—including head 58 at the opposing end 80.

The plunger shaft 68 and handle 58 may be joined together with one or more fasteners (not shown), by threading shaft 68 into a complementary threaded passage formed in handle 58 (not shown), by gluing or other adhesive (not shown), or the shaft and handle may be integrally formed from a single, unitary work piece by molding, casting, machining, or the like with or without subsequent machining to remove casting/molding fins, refine shape, or the like, as applicable. The plunger 50 may be comprised of one or more of: a metal, a metal alloy, wood, ceramic, an organic thermoplastic and/or thermoset polymeric substance, a composite composed of two or more constituents with at least one being a polymeric organic resin, or the like. Plunger 50 may be made of any of the materials previously described in connection with body 32 provided the selected composition provides suitable strength, compatibility, weight, and rigidity to permit desired performance and use manually, and withstand corresponding spring forces to be described hereafter, while at the same time maintaining the operational integrity of handle 58 and threading 62. For typical applications, visual observation through some or all of the material(s) comprising plunger 50 does not reach the same level of interest as for body 32 and/or along some or all of the rest of body 32 because of the different structural, operational, and user interface roles of body 32 versus plunger 50. Among other things, some or all of plunger 50 is made of one or more materials that has suitable wear characteristics in view of operation details, readily maintains integrity of threading 62, has compression and tensile properties sufficient to reciprocally push and pull plunger 50 in and out of body 32 with some degree of repetitiveness and additional mechanical biasing/resistance to be described hereafter, a weight and balance to comfortably perform the manual reciprocal motion repetitively, and is compatible with interactive operation with a biasing mechanism 90 arranged and described further as follows.

Cutting mechanism 30 includes mechanical biasing subsystem 90 to provide biasing to a retracted position 150 (see FIG. 1) of cutting head 100 when cutting mechanism 30 is at rest that is readily overcome by the application of nominal manual force to move cutting head 100 into the cutting position 152 (See FIG. 2). In one form, such biasing is provided by a spring 70 in the form of a helical or coil spring 76 positioned about a portion of plunger shaft 68 between head 58 and end 82 of body 32 (including Biasing to keep cutting head 100 retracted inside of body 32 provides for less direct exposure to the cutters 116, safety concerns are reduced, and inadvertent damage to when the cutting subsystem is at rest—protecting the cutter subassembly constituents. To go from the retracted position 150 to a cutting position 152, manual force is applied to bring handle 58 and body 32 closer together and this manual force is maintained to overcome biasing to the retracted position 150—while also permitting application of a force to permit manual rotation of the plunger 50 to provide for cutting an annular gasket/washer. The cutting position 152 puts spring 70 in shorter more compressed form than the longer extending relaxed form of retracted position 150. Clockwise rotation is advised for cutting if plunger 50 and cutting head 100 are connected by clockwise rotation to tightly engage/intermesh corresponding threading. In the cutting position 152 at least a portion of cutting head 100 and/or cutters 116 carried thereby project out of opening 38 (see FIG. 2). By removing the manual force bringing handle 58 and body 32 closer together along axis R-R, cutting mechanism 30 is biased to return to the retracted position 150 in response to axial biasing force imposed by spring 70 relaxing from the more compressed state created by bringing head 58 and body 32 together.

In the depicted form, spring 70 of bias subsystem 90 is positioned about plunger shaft 68 in the vicinity of plunger end portion 56 by slipping it on plunger 50 before insertion in body 32 and threaded connection to cutting head 100—that is body 32, plunger 50, and cutting head are detached from each other. While carrying spring 70 with spring end portion 74 abutting surface 60 of plunger head 58, plunger end portion 52 is inserted through opening 48 into passage 34. Cutting head 100 is positioned with side 102 and recess 104 facing plunger end portion 52 as it extends through opening 48 and may or may not be initially inserted through opening 38 as needed to initially bring plunger end portion 52 and recess 104 into contact, depending on the length of shaft 68 relative to the length of body 32 along axis R-R. Once recess 104 engages plunger end portion 52, plunger 50 is turned clockwise to thread plunger end portion 52 into recess 104 until tightly fixed to each other. This rotation may require pushing on handle 58 to position cutting head 100 at least partially past rim 36 so cutting head 100 may be held fixed during rotation to thread plunger 50 and recess 104 together. Once cutting mechanism 30 is assembled and rests on end 80, spring end portion 72 bears against surface 46 of body 32 and spring end portion 74 bears against surface 60 of plunger handle 58 capturing spring 70 therebetween. As shown in FIG. 1, once released and left at rest, spring 70 is captured in a state of compression sufficient to exert a biasing, counteracting force along axis R-R to maintain cutting head 100 in retracted position 150—even in opposition to gravity as shown in FIG. 1. To expose cutters 116 and penetrate material 24, manual force is applied to plunger 50 to push handle 58 and body 32 closer together as shown in the cutting position 152 of cutting head 100 depicted in FIG. 2. For cutting position 152, spring 70 is in a more compressed state than for the retracted position 150, but does not require a force too great to be maintained with minimal manual effort.

Spring 70 is a form of coil or helical spring 76 made of a material suitable to: provide a certain spring “stiffness” corresponding to the spring constant; maintain proper form/shape after repeated use; provide desired spring shape (cylindrical, conical, concave (barrel), convex (hourglass), square, rectangular, or the like); and otherwise remain suitable for its application an acceptable period of time with and without usage. In certain embodiments, spring 70 is made of a suitable metal or metal alloy, such as so-called spring steel (typically a medium to high carbon steel—including without limitation “blue steel” or “blue spring steel”). Various factors to consider with spring steel applications relate to desired ductility, strength, and/or wear; imposition/control of steel crystal structure; heat treatment(s) (forging, hardening, and tempering), and nature of the application (compression, tension, torsion, maintaining a force between surfaces under tension, compression, torsion, or a combination of these, for example). In some other embodiments, spring composition may be based on materials other than metals, metal alloys, or metalloids, including: certain ceramics (such as—alumina, alumina hardened zirconia, aluminum nitride, boron nitride, magnesia stabilized zirconia, silicon nitride, yttria stabilized zirconia, zirconia, or the like); glass-ceramics; organic polymers such as—Acrylonitrile Butadiene (ABS), Acrylonitrile Styrene Acrylate (ASA), polycarbonate, polyetheretherketone (PEEK), High Density Polyethylene (HDPE), PolyVinyl Chloride, PolyOxyMethylene (POM, also known as acetal, polyacetal, polyformaldehyde), polypropylene, certain acrylics, certain nylons, Ultem polyetherimide (PEI), or the like. In yet other embodiments, the spring is comprised of a composite of two or more constituents; where one constituent is an organic thermoplastic or thermoset polymeric substance and the other constituent is a different organic thermoplastic or thermoset polymeric substance, a metal, a metal alloy, a metalloid, a ceramic, a glass-ceramic, an inorganic substance, and/or reinforcing fibers, woven fiber fabric, or unwoven fiber fabric, or the like. Such fibers or other fillers may be comprised of at least one or more: organic polymer types, a metal, metal alloy, and/or metalloid type, glass types, glass-ceramic types, ceramic types, certain carbon allotropes, KEVLAR, or the like—just to name a few.

Spring 70 is captured about plunger 50 with spring end portion 72 terminating in bearing contact with body 32 and spring end portion 74 terminating in bearing contact with surface 60 of handle 58 of plunger end portion 56. More specifically, spring end portion 72 establishes bearing contact with body spring bearing surface 46 defined about and surrounding opening 48 of body 32, and spring end portion 74 establishes bearing contact with plunger spring bearing surface 60 of handle 58 about plunger shaft 68 proximate to where it joins handle 58 of plunger end portion 56. Bearing surfaces 46 and 60 are positioned to face each other with one opposite another and the shaft 68 of plunger 50 extending from handle 58 through opening 48. As a result, helical spring 76 is positioned about plunger shaft 68 and has a longitudinal centerline approximately coincident to or at least approximately parallel to axis R-R. It should be appreciated that helical spring 76 has certain compositional and mechanical characteristics that cause it to take on its most relaxed state, maximally expanding in length and correspondingly increasing the separation between coils when helical spring 76 is fully relaxed without any exterior forces being applied to appreciably counteract this state. While this fully relaxed state is not shown, the configuration of helical spring 76 shown in FIG. 1 resembles it in certain respects. Nonetheless helical spring 76 is still in a somewhat compressed state to bias it to maintain the retracted position 150 of head 100 within body 32. Complete relaxation and corresponding expansion of helical spring 76 along axis R-R is being prevented by the mechanical relationship between body 32 and plunger 50 in the retracted position or state 150 as shown in FIG. 1. Spring 70 is structured to engage surfaces 46 and 60, and has sufficient stiffness to exert a force along axis R-R that pushes handle 58 of plunger end portion 56 and body 32 apart from each other when at rest and keep head 100 in the retracted state or position 150—head 100 being located inside passage 34 with side 102 positioned approximately where body end portion 42 and body end portion 44 meet. In certain embodiments, plunger 50, including plunger end portions 52 and 56 (plunger end portion 56 being inclusive of handle 58) is a relatively rigid unit with little flexibility in response to manual force applied during nominal operation and any force imposed by spring 70 while still remaining suitable for manual use as previously described.

Further, as previously introduced, plunger end portion 52 is rigidly connected to cutting head 100. Cutting head 100 includes side 102 opposite side 106. Sides 102 and 106 face away from each other in opposite directions. Cutting head 100 is in the approximate shape of a right circular cylinder with sides 102 and 106 each defining an approximately circular surface area that are each nearly planar and parallel to one another except for certain surface features unique to each side 102 and 106 like recess 104 defined by side 102 and others to be described in greater detail in text accompanying FIGS. 3-6. The center of each circular side 102 and 106 of cutting head 100 approximately are coincident with axis R-R. Further, side 102 defines a generally circular recess 104 with a centerline also coincident with axis R-R and the circle centers. Recess 104 extends from side 102 into head 100, but terminates before reaching side 106, including threads complementary to threading 62 of plunger end portion 52. In other embodiments, plunger 50 and head 100 may be joined together in a different manner such as by an adhesive like a glue or epoxy, by one or more fasteners that do not require threading, by welding, brazing, soldering, or the like. Collectively, sides 102 and 106 constitute a significant majority of the surface area of cutting head 100 as opposed to its peripheral cylindrical wall positioned between and joining sides 102 and 106 at their edges and such wall also defining a corresponding thickness of head 100 along axis R—R. While the interconnection between plunger 50 and head 100 is maintained, the diameter of head 100 generally intersects axis R-R at its center, which corresponds to a rotational center of head 100 when plunger 50 is rotated about axis R-R. Body end portion 42 with a cylindrical surface of head 100 extending around the wall of head 100 between sides 102 and 106 is suitable for slidable movement of cutting head 100 along axis R-R. Head 100 and portion 42 are sized from sliding contact with each other and/or head 100 is sized to be slightly spaced away from wall 66 defining the interior of body end portion 42 so that friction is negligible relative to nominal manual movement of head 100 along axis R-R in body end portion 42. It should be appreciated that the convergent, tapered nature of body end portion 44 as it extends away from body end portion 42 to opening 48 causes the size of passage 34 perpendicular to axis R-R to gradually decrease in size with a corresponding decrease in the distance separating portions of the interior of body end portion 44 positioned across from each other on opposite sides. As a consequence, the size and shape of head 100 prevent its movement along axis R-R into the part of passage 34 defined by the frustum-like interior shape and contouring of body end portion 44 as it extends away from body end portion 42 to opening 48. More specifically, the outer periphery of side 102 and/or the wall of head 100 contacts the interior of body end portion 44 at or just slightly past the position where body end portion 42 and body end portion 44 are integrally joined together. Accordingly, head 100 has a range along axis R-R within body 32 that is generally coextensive with the part of passage 34 defined by body end portion 42. At the opposite extreme, head 100 can travel through passage 34 as defined by body end portion 42 to extend along axis R-R at least partially past rim 36 out of opening 38. The manual movement of head 100 between these potential extremes along axis R-R during nominal operation of cutting mechanism 30 is described in further detail. It should be appreciated that the arrangement of cutting mechanism 30 depicted in FIGS. 1 and 2 represent two extremes. In both FIGS. 1 and 2, plunger end portion 56 (inclusive of handle 58) is positioned outside of passage 34 (and body 32) while plunger end portion 52 is in a fixed rigid interconnection to recess 104 defined by side 102 of cutting head 100 via a rigid threaded connection between plunger end portion 52 and recess 104 defined by side 102. Head 100 is made of one or more materials suitable for its application and sustained manual use without significant rate of failure, suitable quality product output, acceptable performance, and the like. In one preferred arrangement head 100 is primarily made of the same material as plunger 50 with certain specific features having a different composition as more fully described in connection with FIGS. 3-6.

Opposite side 102 of cutting head 100 is side 106. Side 106 is primarily structured for the repositionable fixed connection of cutter subassemblies therealong. Referring additionally to FIGS. 3-6, next described is one type of repositionable cutters 116. Side 106 of head 100 is shown in the FIG. 3 cross-section corresponding to section line 3-3 in FIG. 1. The FIG. 3 view plane is perpendicular to axis R-R with rotational center RC of head 100 (also designated with cross hairs), being a coincident point of axis R-R. FIG. 3 depicts four re-positional cutters 116. Each cutter 116 is fixed to a carrier 118. Each carrier 118 defines threaded passageway 120 structured and sized to receive theaded shaft 126. Each carrier 118 is located along guideway 108 with guideway surface 109, or alternatively designated track 110 with track surface 111. For the depicted embodiment, guideway 108 and track 110 extend approximately radially from rotational center RC, and includes capture slot 128 that has an inverted T-shape profile or contour as best shown in FIG. 4, which is in part sectional corresponding to section line 4-4 in FIG. 3. Each carrier 118 has opposing flanges 240 that extend across the T-shape of slot 128 to confine carrier 118 to engagement along slot 128—noting a carrier may be freed from slot 128 at its outmost end through the wall/side 106 of head 100 (see FIG. 4). In other embodiments, guideway 108 and/or track 110 may differ being extending nonradially, and/or include a differently shaped slot or groove, multiple slots/grooves, or no slots or grooves; while others include one or more rails, ridges, rods, flanges, or the like.

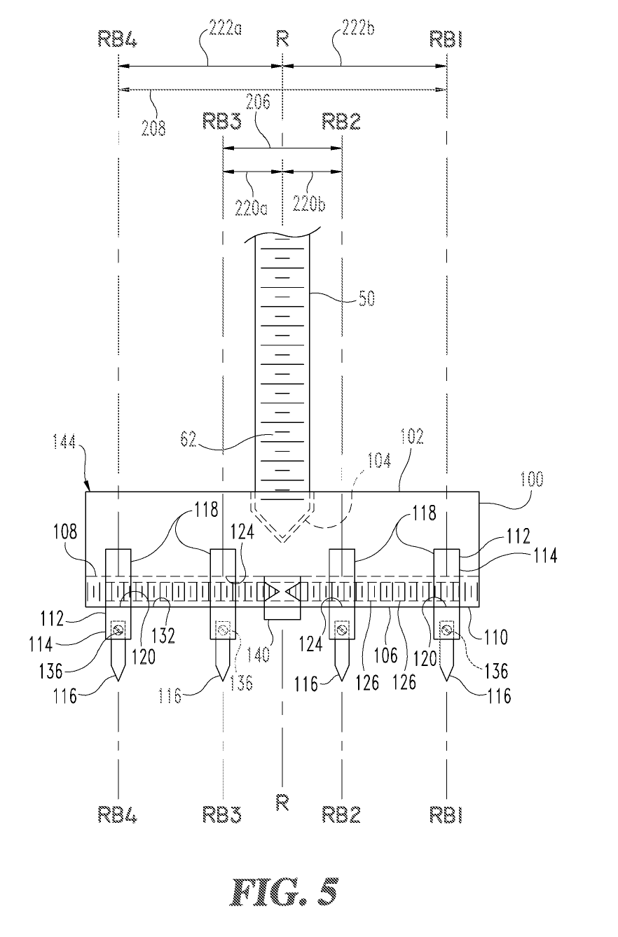

Cutters 116 may be a sharp needle point, a thin blade that tapers to a central point approximately coincident with the blade centerline, a thin blade with an edge on a terminating angle that comes to a point on one side of the blade, a partly or completely rounded blade, a wheel/roller blade with a sharp blade along its circumference, a trailing point blade, a drop point blade, a clip point blade, a sheepsfoot blade, a spey point blade, a leaf blade, a spear point blade, a kris blade, a chisel point blade, a hawkbill blade, and/or an ulu type blade—just to name a few. Cutters 116 may be fixed relative to carrier 118 or pivot about a rotational axis as a gasket/washer is cut from material 24. FIG. 5, corresponding to section line 5-5 shown in FIG. 3, illustrates rotational/pivot axes of each of the four cutters with axis designations RB1-RB1, RB2-RB2, RB3-RB3, and RB4-RB4. Notably these axes are generally parallel to axis R-R as shown in FIG. 5. Each cutter 116 is mounted to carrier 118 with a mounting screw 136 that may or may not allow blade pivoting depending on the capture/mounting structure for each cutter 116 as would be known to those of ordinary skill in the art. If loosened sufficiently, mounting screw 136 will allow ready removal of cutter 116 from its corresponding carrier 118. FIGS. 4 and 5 provide perhaps the most meaningful view of mounting screw 136 threaded into carrier 118.

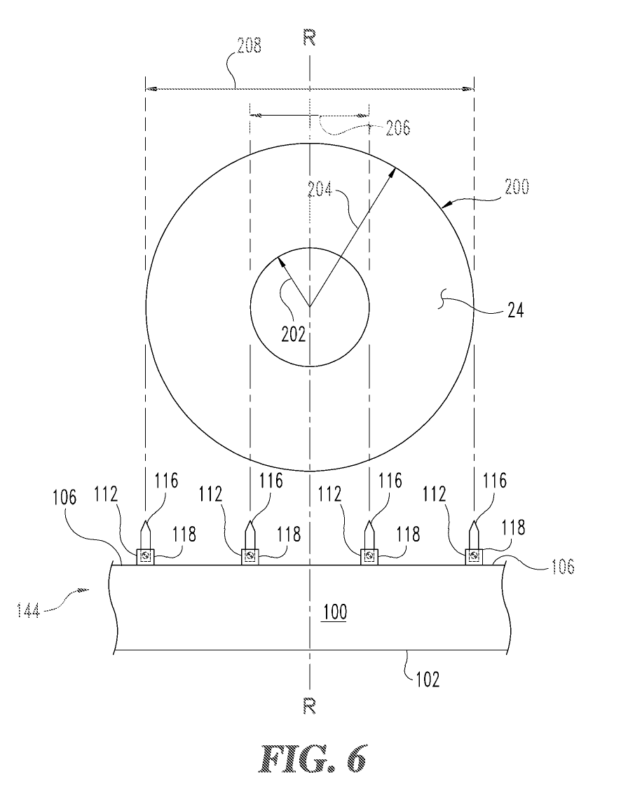

As shown in FIGS. 3-6, each carrier 118 defines threaded passageway 120 as a threaded through passage 124 that opens externally on opposite ends of carrier 118. Furthermore, for the arrangement of FIGS. 3-6, threaded shaft 126 is more specifically designated threaded guide rod 132. In the case of this arrangement there are two threaded guide rods 132, which may also be considered a part of guideway 108/track 110; and each may be threaded into central anchor abutment 140 with opposite one another. When threaded into central anchor abutment 140, each guide rod 132 radially extends through slot 128 along its longitude. The position of each carrier 118 and corresponding mounted cutter 116 can be varied by turning carrier 118 along the threading of rod 132 to a desired location when the rod 132 is disengaged from adjustable cutting subsystem 144 by unthreading it from central anchor abutment 140 and removing it from slot 128. Accordingly, several carriers 118 may be used at once and with two opposing threaded guide rods 132 carrier 118/cutter 116 subassemblies on the opposing rods 132 may provide a cutting subsystem 144 that only needs to be turned one-half way around (180 degrees) when opposing cutters 116 are positioned on each opposing rod 132 at approximately the same radial distance from rotational center RC to cut the same ID or OD for an annular type gasket/washer. In the depicted arrangement, it includes four carriers 118/cutters 116 with two fixed on each opposing threaded guide rod 132 with two opposing carriers 118/cutters 116 each on a different rod 132 set the same radial distance from RC corresponding to the ID of an annular-type gasket/washer and two other opposing carriers 118/carriers 116 each on a different rod 132 set the same radial distance from RC corresponding to the OD of the gasket/washer. Turning specifically to FIG. 6, the alignment of carriers 118/cutters 116 relative to an annular gasket or washer 200 made from material 24 is illustrated. The innermost cutters 116 closest to axis R-R define the ID 206 with corresponding radius 202 for gasket or washer 200; and the outermost cutters 116 define the OD 208 with corresponding radius 204 for gasket or washer 200. For the purposes of the arrangements described in connection with FIGS. 3-6, adjustable cutting subsystem 144 includes guideway 108, track 110, cutters 116, carriers 118, threaded shaft 126/rod 132, capture slot 128, central anchor abutment 140, and any other features defined by or carried along the side 106 of cutting head 100.

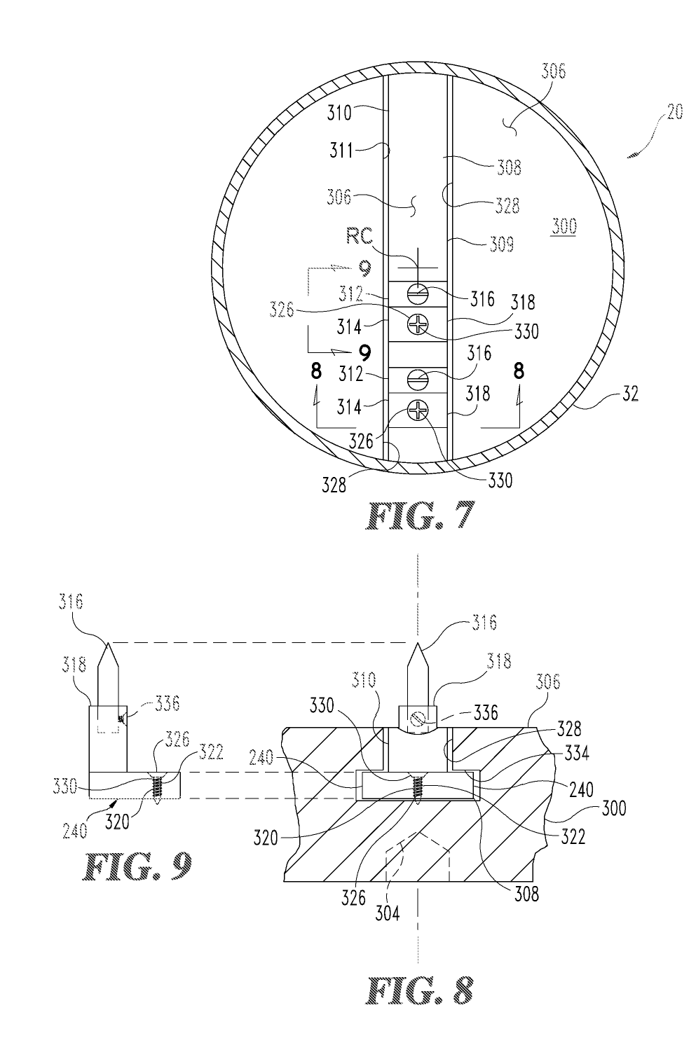

Next additionally referring to FIGS. 7-9, another arrangement of adjustable cutting subsystem 344 is depicted. Subsystem 344 includes cutting head 300 with side 302 opposing side 306. Side 302 defines a threaded recess 304 to receive plunger 50 in the same manner as for recess 104. Side 306 carries along it a guideway 308 defining surface 309 also designated track 110 defining surface 311 each of which radially extends from rotational center RC (FIG. 7). It should be appreciated that FIG. 7 is a sectional view like that of FIG. 3 with respect to the outward position of sectioned body 32 and side 106 of head 100 in the case of FIG. 3; or side 306 of head 300 in the case of FIG. 7. Guideway 308/track 110 collectively carry two carriers 318. Carriers 318 each have cutter 316 mounted thereon, which may be any of the types described in connection with cutter 116. Cutter 316 is mounted to carrier 318 with mounting screw 336 in the same manner as described for carrier 318/cutter 316. Carrier 318 includes a threaded passageway 320 receiving at least a portion of a threaded shaft 326. Carrier 318 includes a pair of opposing flanges 240 to confine it to radial movement along capture slot 328, which is part of guideway 308/track 110 that all generally extend radially away from center RC; however, carrier 318 may be freed from slot 328 at the outermost end of slot 328 where a slot opening is defined by side 306 and the cylindrical wall of head 100.

For carrier 318, threaded passageway 320 is more specifically designated threaded set screw passage 322 and threaded shaft 326 is more specifically designated set screw 330. With the set screw 330 is loosened in threaded set screw passage 322, carrier 318 can move along slot 328 in sliding engagement. Once a desired position for carrier 318 and its mounted cutter 316 along slot 328 is determined, set screw 330 is tightened in passage 322 so that its extends away from carrier 318 through the bottom of it to engage inner slot surface 332 of surrounding slot 328 (see, e.g. FIG. 8). As set screw 330 pushes against surface 332, flanges 240 are push up against opposing slot surface 334—fixing the position of carrier 318 and the respective mounted cutter 316 along slot 328 (see, e.g. FIG. 8). Accordingly each carrier 318 can be re-positioned along the radially extending slot 328 to define an ID and OD of an annular gasket/washer with the respective cutters 316. It should be understood that the guide rod system of FIGS. 3-6 may be combined with the set screw type of FIGS. 7-9 in a number of ways—such as including each type on a different diameter of the head, using the set screw method to replace the guide rod method for one of two opposing rods on approximately the same head diameter. It should be appreciated that FIG. 8 is a partial sectional view corresponding to the section line 8-8 in FIG. 7; and FIG. 9 is a partial sectional view corresponding to the view line 9-9 in FIG. 7.

Next additionally referring to FIG. 10, gasket/washer formation procedure 420 is described in flowchart form for cutting mechanism 30 with either described adjustable cutting subsystem 144 or 344. It should be appreciated that a different cutting subsystem not depicted could be used alternatively. At the start flag of FIG. 10, procedure 420 begins with operation 422. In operation 422, the washer or gasket material is selected and positioned on a suitable work surface. Next, procedure 420 continues with operation 424 in which the inner and outer diameters (ID and OD) of an annular type of gasket or washer are determined for formation of the work piece positioned in operation 422.

From operation 424, procedure 420 advances to conditional 442. Conditional 442 tests what type of adjustable mechanism is used for OD/ID sizing/dimensioning—that is the guide rod type of FIGS. 3-6 (cutting subsystem 144) or the set screw type of FIGS. 7-9 (cutting subsystem 344). If the test determines the guide rod type is to be used procedure 420 continues with operation 454 as indicated by intervening flag 444. In operation 454, carriers 118/cutters 116 are adjusted in the manner required for the guide rod type of cutting subsystem 144. If the test of conditional 442 determines the set screw type is to be used procedure 420 continues with operation 456 as indicated by intervening flag 446. In operation 456, carriers 318/cutters 116 are adjusted in the manner required for the set screw type of cutting subsystem 344.

From either operation 454 or 456. procedure 420 moves on to operation 460. In operation 460, outer rim 36 of cutting mechanism 30 is firmly placed on the material from which the gasket or washer is to be formed. Further manual force is applied to push handle 58 towards body 32, compressing spring 70 further. This manual force also opposes the biasing/spring resistance to move head 100, 300 within passage 34 from the retracted position 150 to the cutting position 152—penetrating the gasket or washer material with the cutters 116, 316 as they extend past rim 36 out of opening 38 of passage 34. Operation 462 is next encountered in which the plunger handle 58 is rotated to cut out an annular form from the gasket or washer material.

Procedure 420 proceeds from operation 462 to conditional 470. Conditional 470 test whether the gasket or washer is fully cut as observed through the body (may be an aperture, window, view port, transparent body material, etc. . . . ). If the test is negative (No), the procedure loops back and returns to operation 462 and conditional 470 to repeat performance of them. If the test is affirmative (Yes), then procedure 420 advances to operation 474 to release the plunger 50 to return head 100, 300 to retracted position 150 in body 32/passage 34 in accordance with spring biasing. From operation 474, procedure 420 continues with operation 476 in which the cutting mechanism 30 is removed from the work piece. Next operation 478 is performed in which the gasket or washer is separated from unused and/or waste material to the extent needed. From operation 478, procedure 420 resumes with conditional 480 that tests whether to prepare/form another gasket or washer. If the test of conditional 480 is affirmative (Yes), then procedure loops back and returns to operation 422 to repeat the procedure sequence as needed. If the test of conditional 480 is negative (No), then procedure 420 halts.

It should be recognized that many variations of this procedure, the cutting subsystem, and the like exist. In one form a gasket is made with a compound radius/diameter by changing the settings after only a portion of a revolution of plunger 50 and then applying the new settings for a subsequent portion of a plunger 50 rotation, continuing until the proper radial diameter/radius for each portion is defined. In other variations, only a single hole/aperture through the material may be desired along with irregular, non-annular shaped perimeter (often rectilinear, curvilinear, or a combination of these) and/or internal portions with a non-annular shape.

Many other variations, alternative, and additional embodiment of the present application are envisions. For example, one method to form a gasket or washer from a suitable solid material, comprises: operating a cutting mechanism including a body defining a passage with a first opening opposite a second opening, a plunger with a first plunger end portion opposite a second plunger end portion, a cutting head including a first side opposite a second side, the plunger extending through the second opening with the second plunger end portion positioned outside the body and the first plunger end portion connected to the head along the first side, the plunger and the head being rotatable relative to the body about a rotational axis extending through the cutting head; adjusting a first threaded interface to form a first repositionable connection of a first cutter along the second side of the head a first distance from the axis and a second threaded interface to form a second repositionable connection of a second cutter along the second side of the head a second distance from the axis different than the first distance; penetrating the material at least part way through with the first cutter and the second cutter; and during the penetrating of the material, turning the plunger about the axis an amount at least sufficient to mark an annular shape of the gasket or washer with an inner diameter and an outer diameter, one of the inner diameter and the outer diameter corresponding to the first distance and another of the inner diameter and the outer diameter corresponding to the second distance.

In another example, an apparatus, comprises a cutting mechanism which includes: a body defining a passage extending from a first opening bounded by a rim to a second opening positioned opposite the first opening; a cutting head with a first side opposite a second side, the head including a first carrier positioned between the first cutter and the second side and defining a first threaded passage engaged to establish a first repositionable connection of the first cutter a first distance from the axis, a second carrier positioned between the second cutter and the second side and defining a second threaded passage engaged to establish a second repositionable connection of the second cutter a second distance from the axis different than the first distance, and a guideway engaged to at least one of the first carrier and the second carrier with a threaded shaft; a plunger including a first plunger end portion connected along the first side of the head opposite a second plunger end portion, the plunger extending through the second opening to position the second plunger end portion external to the body; and a spring including a first portion contacting the body and the second portion contacting the second plunger end portion, the spring including a stiffness selected to push the plunger and the body away from each other to place the head with the first cutter and the second cutter in a retracted position within the body when at rest and compress in response to manual pushing of the body and the second plunger portion together to move the head into a cutting position with the first cutter and the second cutter at least partially projecting out of the first opening past the rim, the head being structured to rotate with the plunger about a rotational axis in the cutting position and move with the plunger in translation along the axis when changing between the retracted position and the cutting position.

Still another example is directed to a method of making a gasket or washer, that comprises: determining an inner radius and an outer radius for at least a portion of the gasket or washer, which includes selecting a suitable solid material from which to prepare the gasket or washer with a cutting mechanism, the cutting mechanism includes a cutting head and a body defining a passage terminating in a first opening, which includes: adjusting the cutting mechanism, which includes: applying a first fastener interface including a carrier fixed with the first cutter, which includes threading a shaft portion into the threaded passage defined by the carrier to provide a repositionable connection of the carrier with the first cutter along a first track portion along the head, the first track portion being positioned relative to the rotational center of the head; applying a second fastener interface including a carrier fixed with the second cutter, which includes threading a threaded shaft portion into the threaded passage defined by the carrier to provide a repositionable connection of the carrier with the second cutter along a second track portion, the second track portion being positioned relative to the rotational center of the cutting head; after the applying of the first fastener interface and the applying of the second fastener interface, moving the cutting mechanism into a selected position relative to the material selected to prepare the gasket or washer therefrom; bearing down on the cutting mechanism with the first cutter and the second cutter projecting at least partway past the rim of the opening; inserting the first cutter and the second cutter into the material; and while the first cutter and the second cutter are inserted into the material, rotating the cutting head about the rotational center to cut though the material a first desired amount less than one revolution to provide a first cut of the material with a first inner radius and a first outer radius.

Any experiment, theory, thesis, hypothesis, mechanism, proof, example, belief, speculation, supposition, conjecture, guesswork, discovery, investigation, or finding stated herein is meant to further enhance understanding of the present application without limiting the construction or scope of any claim that follows or invention otherwise described herein—except to the extent expressly recited in such claim or invention. For any particular reference to “embodiment” or the like, any aspect(s) described in connection with such reference are included therein, but are not included in nor excluded from any other embodiment absent description to the contrary. For multiple references to “embodiment” or the like, some or all of such references may refer to the same embodiment or to two or more different embodiments depending on corresponding modifier(s) or qualifier(s), surrounding context, and/or related description of any aspect(s) thereof—understanding two or more embodiments differ only if there is some substantive distinction, including but not limited to any substantive aspect described for one but not included in the other.

Any use of the words: important, critical, crucial, significant, essential, salient, specific, specifically, imperative, substantial, extraordinary, especially, favor, favored, favorably, favorable, desire, desired, desirable, desirably, particular, particularly, prefer, preferable, preferably, preference, and preferred indicates that the described aspects being modified thereby may be desirable (but not necessarily the only or most desirable), and further may indicate different degrees of desirability among different described aspects; however, the claims that follow are not intended to require such aspects or different degrees associated therewith except to the extent expressly recited.

For any method or process claim that recites multiple acts, conditionals, elements, gerunds, stages, steps, operations, phases, procedures, routines, and/or other claimed features; no particular order or sequence of performance of such features is thereby intended unless expressly indicated to the contrary as further explained hereafter. There is no intention that method claim scope (including order/sequence) be qualified, restricted, confined, limited, or otherwise influenced because: (a) the method/process claim as written merely recites one feature before or after another; (b) an indefinite article accompanies a method claim feature when first introduced and a definite article thereafter (or equivalent for method claim gerunds) absent compelling claim construction reasons in addition; or (c) the claim includes alphabetical, cardinal number, or roman numeral labeling to improve readability, organization, or other purposes without any express indication such labeling intends to impose a particular order. In contrast, to the extent there is an intention to limit a method/process claim to a particular order or sequence of performance: (a) ordinal numbers (1st, 2nd, 3rd, and so on) or corresponding words (first, second, third, and so on) shall be expressly used to specify the intended order/sequence; and/or (b) when an earlier listed feature is referenced by a later listed feature and a relationship between them is of such a type that imposes a relative order because construing otherwise would be irrational and/or any compelling applicable claim construction principle(s) support an order of the earlier feature before the later feature. However, to the extent claim construction imposes that one feature be performed before another, the mere ordering of those two features through such construction is not intended to serve as a rationale or otherwise impose an order on any other features listed before, after, or between them.

Moreover, no claim is intended to be construed as including a means or step for performing a specified function unless expressly introduced in the claim by the language “means for” or “step for,” respectively. As used herein, “portion” means a part of the whole, broadly including both the state of being separate from the whole and the state of being integrated/integral/contiguous with the whole, unless expressly stated to the contrary. Representative embodiments in the foregoing description and other information in the present application possibly may appear under one or more different headings/subheadings. Such headings/subheadings go to the form of the application only, which while perhaps aiding the reader, are not intended to limit scope or meaning of any embodiments, inventions, or description set forth herein, including any claims that follow. Only representative embodiments have been described, such that: advantages, apparatus, applications, arrangements, aspects, attributes, benefits, characterizations, combinations, components, compositions, compounds, conditions, configurations, constituents, designs, details, determinations, devices, discoveries, elements, embodiments, examples, exchanges, experiments, explanations, expressions, factors, features, forms, formulae, gains, implementations, innovations, kits, layouts, machinery, materials, mechanisms, methods, modes, models, objects, options, operations, parts, processes, properties, qualities, refinements, relationships, representations, species, structures, substitutions, systems, techniques, traits, uses, utilities, and/or variations that come within the spirit, scope, and/or meaning of any inventions defined and/or described herein, including any of the following claims, are desired to be protected.

What is claimed is:

1. A method to form a gasket or washer from a suitable solid material, comprising:
operating a cutting mechanism including a body defining a passage with a first opening opposite a second opening, a plunger with a first plunger end portion opposite a second plunger end portion, a cutting head including a first side opposite a second side, the plunger extending through the second opening with the second plunger end portion positioned outside the body and the first plunger end portion connected to the head along the first side, the plunger and the head being rotatable relative to the body about a rotational axis extending through the cutting head;
adjusting a first threaded interface to form a first repositionable connection of a first cutter along the second side of the head a first distance from the axis and a second threaded interface to form a second repositionable connection of a second cutter along the second side of the head a second distance from the axis different than the first distance;
penetrating the material at least part way through with the first cutter and the second cutter; and
during the penetrating of the material, turning the plunger about the axis an amount at least sufficient to mark an annular shape of the gasket or washer with an inner diameter and an outer diameter, one of the inner diameter and the outer diameter corresponding to the first distance and another of the inner diameter and the outer diameter corresponding to the second distance.

2. The method of claim 1, which includes moving the plunger along the axis to relocate the first cutter and the second cutter from a retracted position inside the body within the passage to a cutting position, the first cutter and the second cutter at least partially projecting out of the passage while in the cutting position.

3. The method of claim 2, which includes:
engaging the material with a rim bounding the first opening; and
providing a spring between the second plunger end portion and the body, the spring including a first end portion in a first bearing contact with the body and a second end portion in a second bearing contact with the second plunger end portion;
while the rim is in contact with the material, pushing the plunger down along the axis to relocate the first cutter and the second cutter from the retracted position to the cutting position, performing the penetrating of the material as the first cutter and the second cutter at least partially project out of the passage through the opening and past the rim while in the cutting position;
compressing the spring between the first bearing contact and the second bearing contact in response to the pushing of the plunger down along the axis;
maintaining the compressing of the spring between the first bearing contact and the second bearing contact while performing the turning of the second plunger end portion; and
releasing the plunger to return the first cutter and the second cutter from the cutting position to the retracted position after completing performance of the turning of the second plunger end portion.

4. The method of claim 1, which includes:
cutting through the material during the turning of the plunger;
viewing the cutting through the material during the turning of the plunger through the body;
after completing the turning of the plunger, separating the gasket or the washer from one or more unused portions of the material;
selecting a different piece of work piece material to make a different gasket or washer with a different outer diameter and a different inner diameter;
readjusting the first threaded interface to form a third repositionable connection of the first cutter a third distance from the axis along the second side of the head, the third distance corresponding to the different outer diameter of the different gasket or washer; and
readjusting the second threaded interface to form a fourth repositionable connection of the second cutter a fourth distance from the axis along the second side of the head, the fourth distance corresponding to the different inner diameter of the different gasket or washer.

5. The method of claim 1, in which the first threaded interface includes a first threaded passage and a first threaded shaft, and the adjusting of the first threaded interface includes rotating one of the first threaded passage and the first threaded shaft relative to the other.

6. The method of claim 5, in which the first threaded interface includes a carrier connected to the first cutter, the carrier defining the first threaded passage, the first threaded shaft is radially disposed relative to the axis to provide a form of threaded guide rod, and the adjusting of the first threaded interface includes turning the carrier about the threaded guide rod to change radial position thereof.

7. The method of claim 5, in which:
the first threaded interface includes a carrier connected to the first cutter, a threaded set screw passageway, and a set screw;
the carrier is shaped to slide along a radially disposed track defined by the second side of the head; and
the adjusting of the first threaded interface includes positioning the carrier the first distance from the axis and tightening the set screw in the threaded set screw passageway to fixedly connect the first cutter the first distance from the axis.

8. An apparatus, comprising a cutting mechanism which includes:
a body defining a passage extending from a first opening bounded by a rim to a second opening positioned opposite the first opening;
a cutting head with a first side opposite a second side, the head including a first carrier positioned between the first cutter and the second side and defining a first threaded passage engaged to establish a first repositionable connection of the first cutter a first distance from the axis, a second carrier positioned between the second cutter and the second side and defining a second threaded passage engaged to establish a second repositionable connection of the second cutter a second distance from the axis different than the first distance, and a guideway engaged to at least one of the first carrier and the second carrier with a threaded shaft;
a plunger including a first plunger end portion connected along the first side of the head opposite a second plunger end portion, the plunger extending through the second opening to position the second plunger end portion external to the body; and
a spring including a first portion contacting the body and the second portion contacting the second plunger end portion, the spring including a stiffness selected to push the plunger and the body away from each other to place the head with the first cutter and the second cutter in a retracted position within the body when at rest and compress in response to manual pushing of the body and the second plunger portion together to move the head into a cutting position with the first cutter and the second cutter at least partially projecting out of the first opening past the rim, the head being structured to rotate with the plunger about a rotational axis in the cutting position and move with the plunger in translation along the axis when changing between the retracted position and the cutting position.

9. The apparatus of claim 8, which includes a kit comprising a number of pieces of solid material suitable to make several gasket or washers with the cutting mechanism, and in which the plunger includes a central plunger portion positioned between the first plunger end portion and the second plunger end portion, the spring is of a helical type positioned about at least part of the central plunger portion, and the body includes at least a portion through which to view operation of the cutting mechanism.

10. The apparatus of claim 9, in which the kit includes:
at least one of: instructions and a reference to one or more instruction sources for making the gasket or washers with the cutting mechanism; and
packaging containing at least: the cutting mechanism and the pieces of solid material suitable to make the gasket or washers with the cutting mechanism.

11. The apparatus of claim 8, which further includes means for establishing a kit including the cutting mechanism, the cutting mechanism including means for providing the head with one or more additional cutters.

12. The apparatus of claim 8, in which the threaded shaft is a threaded guide rod radially disposed relative to the axis, and the threaded guide rod is threaded through the first threaded passageway of the first carrier and the second threaded passageway of the second carrier to place the first cutter and the second cutter in a spaced apart relationship corresponding to gasket or washer material extending between inner and outer diameters thereof.

13. The apparatus of claim 8, in which the guideway includes the threaded shaft as a first threaded guide rod radially disposed relative to the axis, the first threaded guide rod is threaded through the first threaded passageway of the first carrier to place the first cutter the first distance from the axis, the head further includes a further guideway with a second threaded guide rod radially disposed relative to the axis generally opposite the first threaded guide rod, and the second threaded guide rod is threaded through the second threaded passageway of the second carrier to place the second cutter the second distance from the axis.

14. The apparatus of claim 8, in which the threaded shaft is a first set screw threaded through the first threaded passageway to provide the first repositionable connection of the first cutter to the head along the guideway and the head includes a second set screw threaded through the second threaded passageway to provide the second repositionable connection of the second cutter to the head.

15. The apparatus of claim 14, in which the second side of the head defines the guideway with a slot, the first carrier and the second carrier are complementarily shaped relative to the slot to be slidingly received therein, the first carrier is fixed in the slot with the first repositionable connection by the first set screw tightened to push the first carrier against a guideway surface bounding the slot, and the second carrier is fixed in the slot with the second repositionable connection by the second set screw tightened to push the second carrier against the guideway surface.

16. A method of making a gasket or washer, comprising:
determining an inner radius and an outer radius for at least a portion of the gasket or washer, which includes selecting a suitable solid material from which to prepare the gasket or washer with a cutting mechanism, the cutting mechanism includes a cutting head and a body defining a passage terminating in a first opening, which includes:
adjusting the cutting mechanism, which includes:
applying a first fastener interface including a carrier fixed with the first cutter, which includes threading a shaft portion into the threaded passage defined by the carrier to provide a repositionable connection of the carrier with the first cutter along a first track portion along the head, the first track portion being positioned relative to the rotational center of the head;
applying a second fastener interface including a carrier fixed with the second cutter, which includes threading a threaded shaft portion into the threaded passage defined by the carrier to provide a repositionable connection of the carrier with the second cutter along a second track portion, the second track portion being positioned relative to the rotational center of the cutting head;
after the applying of the first fastener interface and the applying of the second fastener interface, moving the cutting mechanism into a selected position relative to the material selected to prepare the gasket or washer therefrom;
bearing down on the cutting mechanism with the first cutter and the second cutter projecting at least partway past the rim of the opening;
inserting the first cutter and the second cutter into the material; and
while the first cutter and the second cutter are inserted into the material, rotating the cutting head about the rotational center to cut though the material a first desired amount less than one revolution to provide a first cut of the material with a first inner radius and a first outer radius.

17. The method of claim 16, which includes:
with the first fastener interface, setting position of the first cutter to a third distance different than the first distance and the second distance to correspond to a different second inner diameter;
with the second fastener interface, setting position of the second cutter to a fourth distance different than the first distance, the second distance, and the third distance to correspond to a second outer diameter; and
with the third distance corresponding to the first cutter and the fourth distance corresponding to the second cutter, turning the cutting head during penetration in the material to cut a second desired amount to provide a second cut of the material with a second inner radius and a second outer radius to form the gasket or washer with a compound radius geometry.

18. The method of claim 16, in which:
the body defines a second opening opposite the first opening, the second opening and the first opening both intersecting the passage through the body, the plunger includes a first plunger end portion opposite a second plunger end portion, and a coil spring is positioned about a portion of the plunger with a first spring portion contacting the body and a second spring portion contacting the second plunger end portion.
the positioning of the cutting mechanism includes placing a rim bounding the first opening in contact with the material; and
the moving of the plunger includes pushing the plunger to compress the spring, to project the cutting head toward the first opening and releasing the plunger to return the cutting head to a retracted position within the body.

19. The method of claim 16, which includes:
the material is in the form of a sheet of one or more of: a natural or synthetic rubber, a felt, a mat of fibers, a leather, a woven fabric, paper, silicone, cork, neoprene, a soft metal, mica, a polymeric thermoplastic substance, and a polymeric thermoset substance, a composite comprised of two or more alternating layers each being differently composed, a composite including an organic polymer base resin with a metallic, intermettalic, ceramic, glass, kevlar, carbon fibers, oxide, and/or other fill constituent(s) in any amount and physical/size/shape arrangement as would occur to those of ordinary skill in the art;
the first cutter and the second cutter are each pivotable relative to the head each about a different pivot axis generally parallel to a rotational axis of the cutting head; and
the first fastener interface and the second fastener interface each include a carrier defining a threaded passageway therethrough.

20. The method of claim 19, in which the threaded passageway of the carrier of each of the first cutter and the second cutter is engaged by one of: (a) a threaded guide rod extending radially from the axis with a longitude approximately perpendicular to the axis and (b) a set screw.
